(19) United States
(12) Patent Application Publication
(10) Pub. No.: US 2013/0201796 A1
(43) Pub. Date: Aug. 8, 2013

(54) ELECTRONIC APPARATUS

(71) Applicants: Yasuharu Onishi, Kanagawa (JP); Yuichiro Kishinami, Kanagawa (JP); Shigeo Satou, Kanagawa (JP); Jun Kuroda, Kanagawa (JP); Yukio Murata, Kanagawa (JP); Motoyoshi Komoda, Kanagawa (JP); Nobuhiro Kawashima, Kanagawa (JP); Tatsuya Uchikawa, Kanagawa (JP)

(72) Inventors: Yasuharu Onishi, Kanagawa (JP); Yuichiro Kishinami, Kanagawa (JP); Shigeo Satou, Kanagawa (JP); Jun Kuroda, Kanagawa (JP); Yukio Murata, Kanagawa (JP); Motoyoshi Komoda, Kanagawa (JP); Nobuhiro Kawashima, Kanagawa (JP); Tatsuya Uchikawa, Kanagawa (JP)

(73) Assignee: NEC CASIO MOBILE COMMUNICATIONS, LTD., Kanagawa (JP)

(21) Appl. No.: 13/824,175

(22) PCT Filed: Sep. 9, 2011
(86) PCT No.: PCT/JP2011/005066

§ 371 Date: Apr. 25, 2013

(30) Foreign Application Priority Data
Nov. 1, 2010 (JP) 2010-245676

(51) Int. Cl. H04R 17/00; G01S 15/08

(52) U.S. Cl. CPC H04R 17/00; G01S 15/08
USPC 367/99; 367/159

(57) ABSTRACT

An electronic apparatus includes a substrate and an oscillation device (100) which is supported over the substrate, wherein the oscillation device (100) includes a piezoelectric element (110), a vibrating member (120) which binds one surface of the piezoelectric element (110), and a tubular support member (140) which supports an outer edge portion of the vibrating member (120) in an inner surface and is joined to the substrate so that an opening of one end side is closed by the substrate, and the support member (140) includes at least one hole (141) which connects a space, which is surrounded by the substrate and the vibrating member (120) in an inner portion of the support member (140), to an outer portion of the support member (140).

### TECHNICAL FIELD

The present invention relates to an electric apparatus which includes an oscillation device.

### BACKGROUND ART

Recently, a thin and stylish mobile phone, which has a sound function such as music reproduction or handsfree, having a commercial value, has been actively developed. Thereby, an electro-acoustic transducer, which is mounted on an electronic apparatus such as a mobile phone, is also required to be small and thin, and to have high sound quality. As a thin electro-acoustic transducer instead of an electrodynamic electro-acoustic transducer of the related art, a piezoelectric electro-acoustic transducer has been actively developed.

The piezoelectric electro-acoustic transducer reproduces sound waves using expansion and contraction movement of a piezoelectric element.

Currently, various kinds of phones are suggested as the mobile phones as described above (Patent Documents 1 and 2).

### RELATED DOCUMENT

### Patent Document

[Patent Document 1] Japanese Unexamined Patent Publication No. 2003-143677

[Patent Document 2] Japanese Unexamined Patent Publication No. 2004-064158

### DISCLOSURE OF THE INVENTION

When an oscillation device is supported by a substrate, air, which fills a rear air chamber between the oscillation device and the substrate, functions as a damper with respect to the oscillation device. In this case, the vibrating amount of the oscillation device is attenuated. Thereby, efficiency of sound output of the oscillation device is decreased.

The present invention is made in consideration of the above-described problems, and an object thereof is to provide an electric apparatus which includes an oscillation device capable of outputting sound in high efficiency.

According to the present invention, there is provided an electronic apparatus including:

a substrate; and

an oscillation device which is supported over the substrate,

wherein the oscillation device includes:

a piezoelectric element;

a vibrating member which binds one surface of the piezoelectric element; and

a tubular support member which supports an outer edge portion of the vibrating member in an inner surface and is joined to the substrate so that an opening of one end side is closed by the substrate, and

wherein the support member includes at least one hole which connects a space, which is surrounded by the substrate and the vibrating member in an inner portion of the support member, to an outer portion of the support member.

According to the present invention, an electronic apparatus which includes an oscillation device which can output sound in high efficiency can be provided.

### BRIEF DESCRIPTION OF THE DRAWINGS

The above-described object, other objects, characteristics, and advantages will become more obvious according to a preferred embodiment described below and the accompanying drawings.

FIG. 1 is a schematic exploded perspective view showing an assembling structure of an oscillation device according to the present embodiment.

FIG. 2 is a schematic longitudinal sectional front view showing an inner structure of an electronic apparatus according to the present embodiment.

FIG. 3 is a schematic longitudinal sectional front view showing a modification example of the oscillation device shown in FIG. 1.

FIG. 4 is a bottom view showing the structure of the oscillation device shown in FIG. 1.

FIG. 5 is a view showing operations of the oscillation device of the present embodiment and the oscillation device of the related art.

FIG. 6 is a longitudinal sectional front view showing a piezoelectric element shown in FIG. 1.

### DESCRIPTION OF EMBODIMENTS

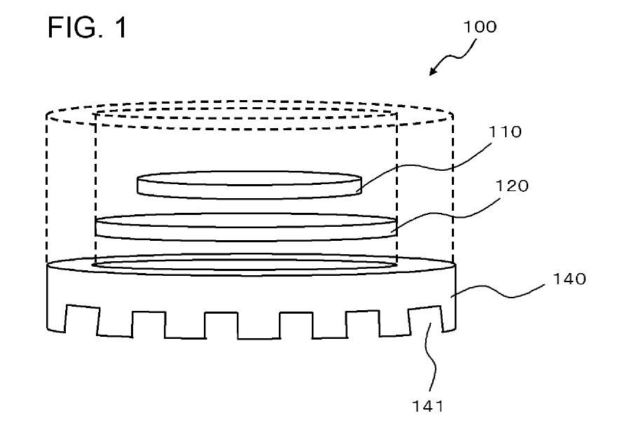

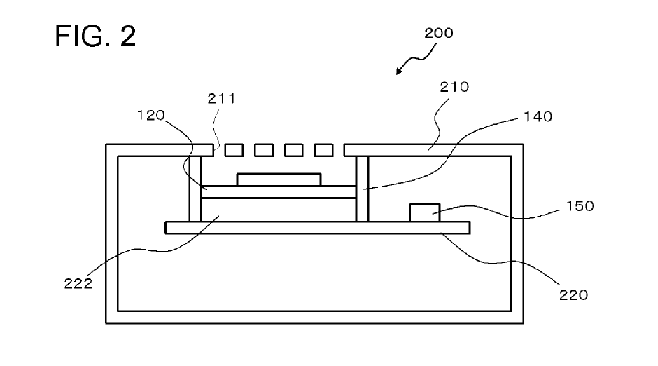

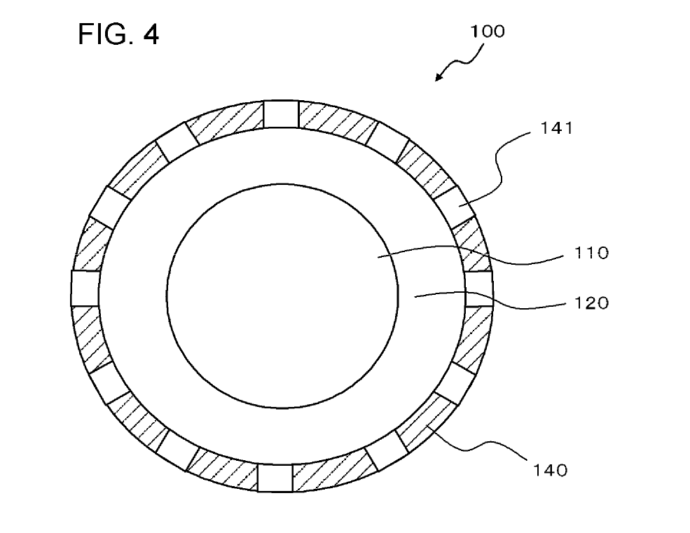

An embodiment of the present invention will be described below with reference to drawings. FIG. 1 is a schematic exploded perspective view showing an assembling structure of an oscillation device 100 according to the present embodiment. Moreover, in FIG. 1, a portion of a support member 140 is shown by a broken line. FIG. 2 is a schematic longitudinal sectional front view showing an inner structure of an electronic apparatus 200 according to the present embodiment. FIG. 4 is a bottom view showing the structure of the oscillation device 100 shown in FIG. 1.

The electronic apparatus 200 according to the present embodiment includes a substrate 220, and the oscillation device 100 which is supported over the substrate 220. For example, the electronic apparatus 200 is a mobile phone or the like.

The oscillation device 100 which is an electro-acoustic transducer includes a piezoelectric element 110, a vibrating member 120 which binds one surface of the piezoelectric element 110, and a tubular support member 140 which supports the outer edge portion of the vibrating member 120 in the inner surface and is joined to the substrate 220 so that an opening of one end side is closed by the substrate 220. The support member 140 includes at least one hole 141 which connects a space 222, which is surrounded by the substrate 220 and the vibrating member 120 in the inner portion of the support member 140, to the outer portion of the support member 140. Hereinafter, a configuration of the oscillation device 100 according to the present embodiment will be described in detail.

As shown in FIG. 2, the support member 140 has a tubular shape. In the present embodiment, the support member 140 has a cylindrical shape. Moreover, the shape of the support member 140 is not limited to this. For example, the support member may be provided in a square cylindrical shape which becomes a rectangle when seen in a plan view.

The support member 140 is joined to the outer edge portion of the vibrating member 120 in the inner side surface, and thus, the support member supports the vibrating member 120. Moreover, the opening of one end side of the support member 140, which is formed in a tubular shape, is closed by the substrate 220. Thereby, the space 222 which is surrounded by the support member 140, the substrate 220, and the vibrating member 120 is formed in the inner portion of the support member 140.

The support member 140 includes at least one hole 141 which connects the space 222 to the outer portion of the support member 140. In the present embodiment, the support member 140 includes a plurality of holes 141.

As shown in FIG. 1, the hole 141 is configured by a concave portion which is provided in an end surface of one end side of the support member 140. Moreover, as shown in FIG. 4, the plurality of holes 141 are formed on one end of the support member 140 periodically. That is, the plurality of holes 141 are disposed at equal intervals to each other.

In the oscillation device 100 according to the present embodiment, the piezoelectric element 110 is provided so that the planar shape is a disk shape. In addition, the vibrating member 120 is formed so that the planar shape is a disk shape.

However, the planar shape of the piezoelectric element 110 is not limited to the above-described. For example, the planar shape may be a polygon such as a rectangle. Moreover, the planar shape of the vibrating member 120 is not also limited to the above-described. For example, the planar shape may be a polygon such as a rectangle. When the planar shape of the piezoelectric element 110 is a rectangle, for example, the support member 140 may be formed in a square cylindrical shape which becomes a rectangle when seen in a plan view (not shown in the drawings).

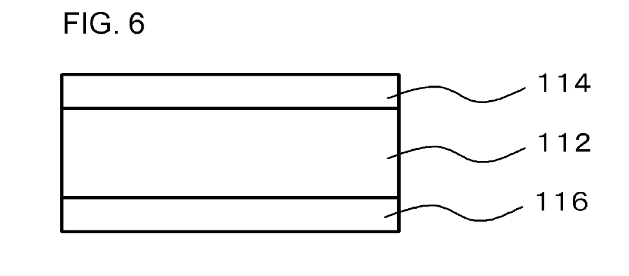

FIG. 6 is a longitudinal sectional front view showing the piezoelectric element 110 shown in FIG. 1. As shown in FIG. 6, the piezoelectric element 110 includes a piezoelectric layer 112, an upper electrode 114, and a lower electrode 116.

The piezoelectric layer 112 is interposed between the upper electrode 114 and the lower electrode 116. Moreover, the piezoelectric layer 112 is polarized in the thickness direction.

In the oscillation device 100 of the present embodiment, for example, oscillating frequency of the piezoelectric element 110 is equal to or more than 20 kHz. Moreover, for example, the piezoelectric element 110 outputs ultrasonic waves which are modulated for a parametric speaker. In addition, for example, the piezoelectric element 110 may be configured so as to output sound waves having frequency in an audible range.

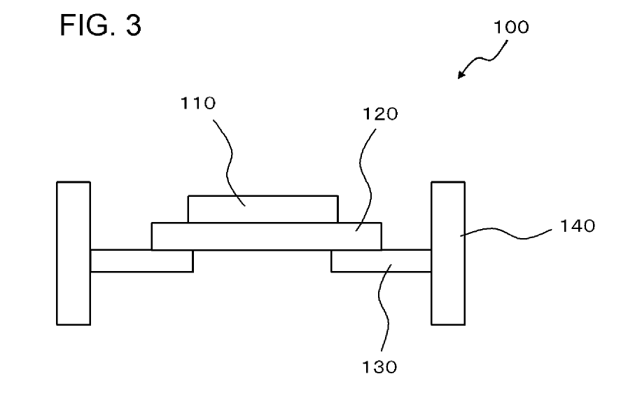

FIG. 3 is a schematic longitudinal sectional front view showing a modification example of the oscillation device 100 shown in FIG. 1. As shown in FIG. 3, the oscillation device 100 may include an elastic member 130. For example, the elastic member 130 is provided in an annular shape which has an opening in a region including a center. Moreover, for example, the elastic member 130 may be provided so that the planar shape is a polygon.

The elastic member 130 supports the outer circumferential portion of the vibrating member 120 on the upper surface of the inner circumferential portion. The vibrating member 120 is supported on the elastic member 130 so as to close the opening which is provided in the elastic member 130. In addition, the support member 140 supports the outer edge portion of the elastic member 130 in the inner side surface.

For example, the elastic member 130 may be configured of a resin material such as PET or polyethylene.

As shown in FIG. 2, for example, the electronic apparatus 200 according to the present embodiment includes a box-shaped housing 210. The substrate 220 such as a printed wiring board is disposed in the inner portion of the housing 210. Moreover, one end of the support member 140 which configures the oscillation device 100 is joined to one surface of the substrate 220.

In addition, a plurality of sound holes 211 are formed on one surface of the housing 210. The plurality of sound holes 211 are disposed in a position opposite to a vibrating surface of the oscillation device 100. Moreover, as shown in FIG. 2, for example, a drive circuit 150 which is an oscillating drive unit which makes the oscillation device 100 output sound waves, is mounted on the above-described substrate 220. The driver circuit 150 is connected (not shown in the drawings) to the piezoelectric element 110 of the oscillation device 100 through printing wiring or lead wires.

In the electronic apparatus 200 according to the present embodiment, the piezoelectric element 110 to which an electric field is applied from the driver circuit 150 is expanded and contracted, and thus, the piezoelectric element 110 and the vibrating member 120 vibrate in up and down directions in FIG. 2. Thereby, sound waves are output from the oscillation device 100.

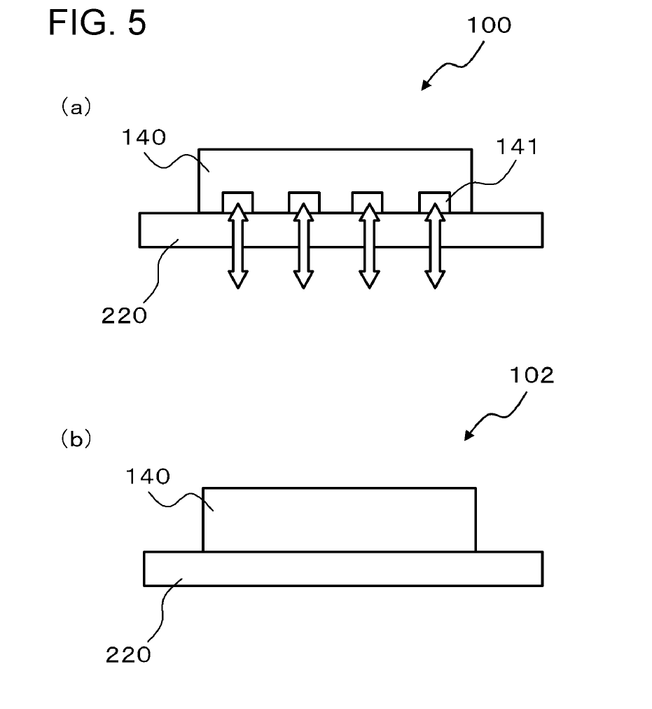

FIG. 5 is view showing operations of the oscillation device 100 according to the present embodiment and an oscillation device 102 according to a comparative example. Moreover, FIG. 5 is a view when the support member 140 and the substrate 220 are viewed from the side surface. The oscillation device 102 according to the comparative example has the configuration similar to the oscillation device 100 according to the present embodiment except that the hole 141 is not provided.

As shown in FIG. 5(b), in the oscillation device 102 according to the comparative example, the hole 141 is not provided. Thereby, when the oscillation device 102 vibrates, air inside the space 222 functions as a damper with respect to the oscillation device 102. Therefore, the vibrating amount of the oscillation device 102 is attenuated. Accordingly, efficiency of the sound output of the oscillation device is decreased.

Moreover, the resonance frequency of the oscillation device 102 is shifted to high bandwidth. Thereby, there is a concern that sound quality of the oscillation device may be decreased.

In addition, when the oscillation device 102 is mounted on a small-sized electronic apparatus such as a mobile phone, the volume capacity of the space 222 is decreased. Thereby, the effect of the air inside the space 222 as a damper is increased.

On the other hand, in the electronic apparatus 200 according to the present embodiment, as shown in FIG. 5(a), the hole 141 is formed in the support member 140. Thereby, when the piezoelectric element 110 and the vibrating member 120 vibrate in up and down directions, air enters to and is discharged from the space 222 (arrows in FIG. 5(a)). Thereby, unlike the electronic apparatus which includes the oscillation device 102 according to the comparative example, in the electronic apparatus 200 according to the present embodiment, the damping due to the air inside the space 222 does not act on the vibration of the piezoelectric element 110 and the vibrating member 120. Accordingly, the electronic apparatus which includes the oscillation device which can output sound in high efficiency can be provided. Moreover, the oscillation device which can output with high sound quality can be realized.

In addition, in the oscillation device 100 of the present embodiment, the hole 141 is configured by a concave portion which is provided in the end surface of one end side of the support member 140. Thereby, the formation of the hole 141 is easily performed.

Moreover, the plurality of holes 141 are formed in the support member 140 periodically. That is, the plurality of holes 141 are disposed at equal intervals to each other. Thereby, movement of air between the space 222 and the outer portion of the support member 140 is performed equally. Accordingly, unequal back pressure does not act on the piezoelectric element 110.

In addition, the present invention is not limited to the present embodiment, and various modifications are allowed within a scope which does not depart from the gist. For example, in the above-described aspect, the oscillation device 100 having a unimorph structure in which only the upper surface of the vibrating member 120 is bounded by one piezoelectric element 110 is exemplified. However, an oscillation device of a bimorph structure, in which the upper surface and the lower surface of the vibrating member 120 are bounded by two piezoelectric elements 110, or the like can be also realized (not shown in the drawings).

Moreover, in the above-described aspect, it is assumed that the piezoelectric element 110 is configured of one piezoelectric layer 112. However, the piezoelectric element may include a laminated structure in which piezoelectric layers and electrode layers are alternately laminated (not shown in the drawings).

In addition, in the above-described aspect, it is exemplified that the hole 141 is configured by a concave portion which is provided in the end surface of one end side of the support member 140. However, the hole 141 may be also configured by a through-hole which is formed at a position separated from the end portion of the support member 140 (not shown in the drawings).

Moreover, in the above-described aspect, it is exemplified that the plurality of holes are formed in the support member 140 periodically. However, the holes may be formed nonperiodically in the support member (not shown in the drawings).

Moreover, in the above-described aspect, the electronic apparatus 200 in which the driver circuit 150 is connected to the oscillation device 100 is exemplified. However, the electric apparatus 200 may include the oscillation device 100, an oscillation drive unit which makes the oscillation device 100 output ultrasonic waves for a sensor, a ultrasonic wave detection unit which detects the ultrasonic waves for the sensor reflected by an objected to be measured, and a distance measurement unit which calculates a distance between the oscillation device 100 and the object to be measured based on a time for the ultrasonic waves for the sensor are detected by the ultrasonic wave detection unit after the ultrasonic waves for the sensor are output from the oscillation device 100 (not shown in the drawings). In this way, the electronic apparatus 200 may be also realized as sonar.

Moreover, understandably, the embodiment and the plurality of modification examples described above may be combined within a range in which the contents are not contrary. Moreover, in the embodiment and the plurality of modification examples described above, the structure or the like of each portion is specifically described. However, the structure or the like may be variously modified within a scope in which the present invention is satisfied.

This application claims priority based on Japanese Patent Application No. 2010-245676, filed Nov. 1, 2010, the content of which is incorporated herein by reference.

1. An electronic apparatus comprising:
a substrate; and
an oscillation device which is supported over the substrate,
wherein the oscillation device includes:
a piezoelectric element;
a vibrating member which binds one surface of the piezoelectric element; and
a tubular support member which supports an outer edge portion of the vibrating member in an inner surface and is joined to the substrate so that an opening of one end side is closed by the substrate, and
wherein the support member includes at least one hole which connects a space, which is surrounded by the substrate and the vibrating member in an inner portion of the support member, to an outer portion of the support member.

2. The electronic apparatus according to claim 1,
wherein the hole is configured by a concave portion which is provided in an end surface of the one end side of the support member.

3. The electronic apparatus according to claim 1,
wherein the support member includes a plurality of the holes which are disposed at equal intervals to each other.

4. The electronic apparatus according to claim 1
wherein an planar shape of the piezoelectric element is circular, and the support member is formed in a cylindrical shape.

5. The electronic apparatus according to claim 1,
wherein an planar shape of the piezoelectric element is rectangular, and the support member is formed in a rectangular square cylindrical shape.

6. The electronic apparatus according to claim 1,
wherein oscillating frequency of the piezoelectric element is equal to or more than 20 kHz.

7. The electronic apparatus according to claim 1,
wherein the piezoelectric element includes a laminated structure in which piezoelectric layers and electrode layers are alternately laminated.

8. The electronic apparatus according to claim 1,
wherein the piezoelectric element outputs ultrasonic waves which are modulated for a parametric speaker.

9. The electronic apparatus according to claim 1, further comprising:
an oscillation drive unit which makes the oscillation device output ultrasonic waves for a sensor;
a ultrasonic wave detection unit which detects the ultrasonic waves for the sensor reflected by an objected to be measured; and
a distance measurement unit which calculates a distance between the oscillation device and the object to be measured based on a time from when the ultrasonic waves for the sensor are output from the oscillation device until the ultrasonic waves for the sensor are detected by the ultrasonic wave detection unit.
